(19) United States
(12) Patent Application Publication
(10) Pub. No.: US 2005/0111402 A1
(43) Pub. Date: May 26, 2005

(54) Radio communication system and communication station

(76) Inventors: Manabu Sawada, Yokohama-city (JP); Shigeki Kawai, Yokohama-city (JP); Hiroshi Harada, Koganei-city (JP); Masayuki Fujise, Koganei-city (JP)

Correspondence Address: HARNESS, DICKEY & PIERCE, P.L.C., P.O. BOX 828, BLOOMFIELD HILLS, MI, 48303, US

(21) Appl. No.: 10/779,575

(22) Filed: Feb. 13, 2004

(30) Foreign Application Priority Data
Feb. 14, 2003 (JP) 2003-36975

(51) Int. Cl. H04Q 7/00

(52) U.S. Cl. 370/328; 370/338

(57) ABSTRACT

In a radio communication system, a base station sends each of n send packets to a terminal station in parallel through n channels as they are in packet unit instead of dividing each of n send packets to send the same to the terminal station. It is possible in the base station to eliminate the need for a processing of dividing send packets and processing of resending divided send packets. It is also possible in the terminal station to eliminate the need of a configuration for receiving the divided send packets.

### CROSS REFERENCE TO RELATED APPLICATION

This application is based on and incorporates herein by reference Japanese Patent Application No. 2003-36975 filed on Feb. 14, 2003.

### FIELD OF THE INVENTION

The present invention relates to a radio communication system configured to have, as communication stations, a base station and a terminal station so that one communication station sends a plurality of send packets to another communication station, and a communication station used in the radio communication system.

### BACKGROUND OF THE INVENTION

Conventionally, for the purpose of high-speed transmission of send packets, a send packet is divided into n (n being a natural number equal to or more than 2) sections, and the divided respective send packets are sent in parallel through n frequencies or channels (JP 2002-199047A).

In a communication station for sending send packets, however, the processing of dividing a send packet into n sections is complicated and the processing of resending the divided send packets is complicated in the case where an error occurs in transmission. A communication station for receiving the send packets must be configured to receive the divided send packets. Also, in the case that the send packet is thus divided and sent in parallel through a plurality of channels, it is necessary to register and authenticate whether the communication station for sending send packets and the communication station for receiving the send packets have established the relationship between a master station and a slave station in a plurality of channels.

### SUMMARY OF THE INVENTION

It is a first object of the present invention to provide a radio communication system, in which one communication station sends a plurality of send packets to another communication station, and which can simplify processing in a communication station for sending send packets and processing in a communication station for receiving the send packets.

It is a second object of the invention to provide a radio communication system, in which one communication station sends a plurality of send packets to another communication station, and which can appropriately register and authenticate whether a communication station for sending the send packets and a communication station for receiving the send packets have established the relationship between a master station and a slave station in a plurality of channels.

In a radio communication system according to the invention, when one communication station sends packets to another communication station, one communication station sends each of a plurality of send packets in parallel through a plurality of channels to another communication station as they are in packet unit, instead of dividing each of send packets to send the same to another communication station. Thereby, unlike conventional radio communication systems, the communication station for sending send packets can dispense with processing of dividing the send packet and sending the divided send packets, and a communication station for receiving the send packets can dispense with any configuration for receiving the divided send packets. Thus, it is possible to simplify the processing in the communication station for sending the send packets and the processing in the communication station for receiving the send packets.

Also, as a communication station for receiving send packets, stations designed to receive send packets in parallel through a plurality of channels can not only be used but also even stations designed to receive send packets through a single channel can be used, so that the communication stations for receiving the send packets in parallel through a plurality of channels and the communication stations for receiving the send packets through a single channel can be made coexistent.

Also, in a radio communication system according to the invention, one communication station sends each of a plurality of beacons, which corresponds to each of a plurality of channels, in parallel through a plurality of channels to another communication station as independent data through a plurality of channels, when each of a plurality of beacons has been received from one communication station, another communication station sends each of a plurality of registration packets and a plurality of authentication packets, which corresponds to each of the plurality of channels, in parallel through a plurality of channels to one communication station as independent data through a plurality of channels, and when each of a plurality of registration packets and a plurality of authentication packets is received from another communication station, one communication station sends each of a plurality of packets, of which registration is correct or not, and a plurality of packets, of which authentication is correct or not, each of such packets corresponding to each of a plurality of channels, in parallel through a plurality of channels to another communication station as independent data through a plurality of channels.

In this manner, beacons, registration packets, packets, of which registration is correct or not, authentication packets, and packets, of which authentication is correct or not, are sent and received through each of a plurality of channels between one communication station and another communication station in the same procedure as that of registration and authentication when send packets are sent and received through a single channel whereby it is possible to appropriately register and authenticate whether one communication station and another communication station are in the relationship between a master station and a slave station in a plurality of channels.

Also, even when one communication station sends packets through a single channel, with respect to another communication station designed to receive send packets through a single channel, it is possible to appropriately register and authenticate whether one communication station and another communication station are put in the relationship between a master station and a slave station at the single channel, and to make communication stations for reception of send packets in parallel through a plurality of channels and communication stations for reception of send packets through a single channel coexistent. Further, it is possible to use the procedure of registration and authentication when send packets are sent and received through a single channel and to restrict modification in communication control procedure as much as possible.

### BRIEF DESCRIPTION OF THE DRAWINGS

The above and other objects, features and advantages of the present invention will become more apparent from the following detailed description made with reference to the accompanying drawings. In the drawings:

FIGS. 1A, 1B and 1C are schematic diagrams showing a communication system and send packets according to an embodiment of the invention;

FIG. 2 is a function block diagram showing a base station of the communication system;

FIG. 3 is a flowchart showing processing performed by a channel controller of the base station;

FIGS. 4A and 4B are schematic diagrams showing manners, in which the base station inputs and send packets;

FIGS. 5A and 5B are schematic diagrams showing manners, in which the base station inputs and send packets;

FIGS. 6A and 6B are schematic diagrams showing manners, in which the base station inputs and send packets;

FIGS. 7A and 7B are schematic diagrams showing manners, in which the base station inputs and send packets; FIGS. 8A and 8B are schematic diagrams showing manners, in which the base station sends packets and the terminal station sends ACK packets;

FIGS. 9A and 9B are schematic diagrams showing manners, in which the base station sends packets and the terminal station sends ACK packets;

FIGS. 10A and 10B are schematic diagrams showing manners, in which the base station sends packets and the terminal station sends ACK packets;

FIGS. 11A and 11B are schematic diagrams showing manners, in which the base station sends packets and the terminal station sends ACK packets and NACK packets;

FIGS. 12A and 12B are schematic diagrams showing manners, in which the base station sends packets and the terminal station sends ACK packets and NACK packets;

FIGS. 13A and 13B are schematic views showing manners, in which the base station sends beacons, packets, of which registration is correct or not, and packets, of which authentication is correct or not, and the terminal station sends registration packets and authentication packets;

FIGS. 14A and 14B are schematic views showing manners, in which the base station sends beacons, packets, of which registration is correct or not, and packets, of which authentication is correct or not, and the terminal station sends registration packets and authentication packets; and

FIGS. 15A and 15B are schematic views showing manners, in which the base station sends beacons, packets, of which registration is correct or not, and packets, of which authentication is correct or not, and the terminal station sends registration packets and authentication packets.

### DETAILED DESCRIPTION OF THE INVENTION

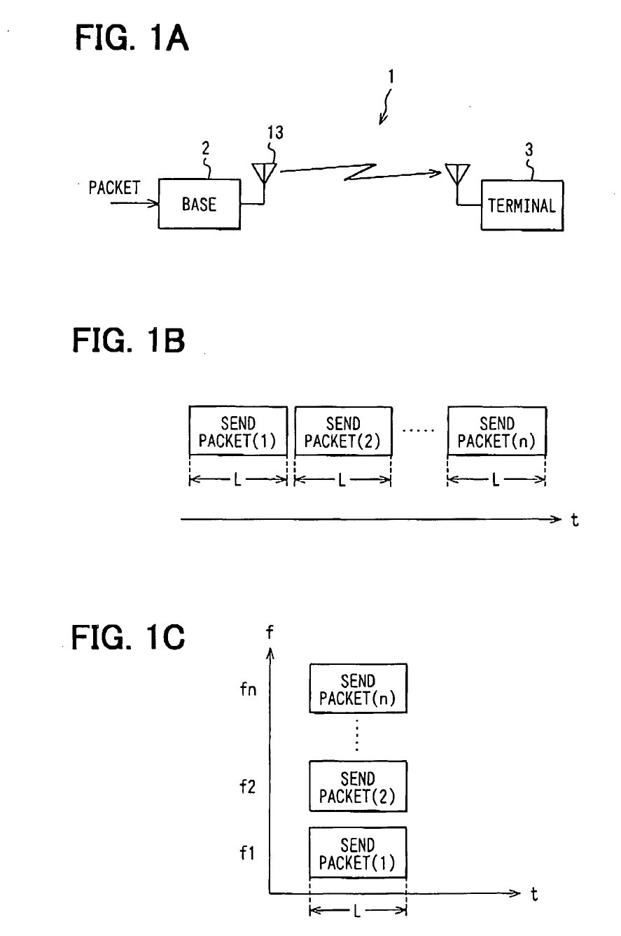

Referring first to FIG. 1A, a radio communication system 1 comprises a base station 2 and a terminal station 3. The base station 2 receives packets as shown in FIG. 1B and sends the packets in parallel as shown in FIG. 1C. The base station 2 sends the packets to the terminal station 3 through a plurality of channels (different frequencies). The terminal station 3 also sends packets to the base station 2 in the similar manner. Also, the base station 2 sends packets to another base station (not shown), and the terminal station 3 sends packets to another terminal station (not shown) in the similar manner.

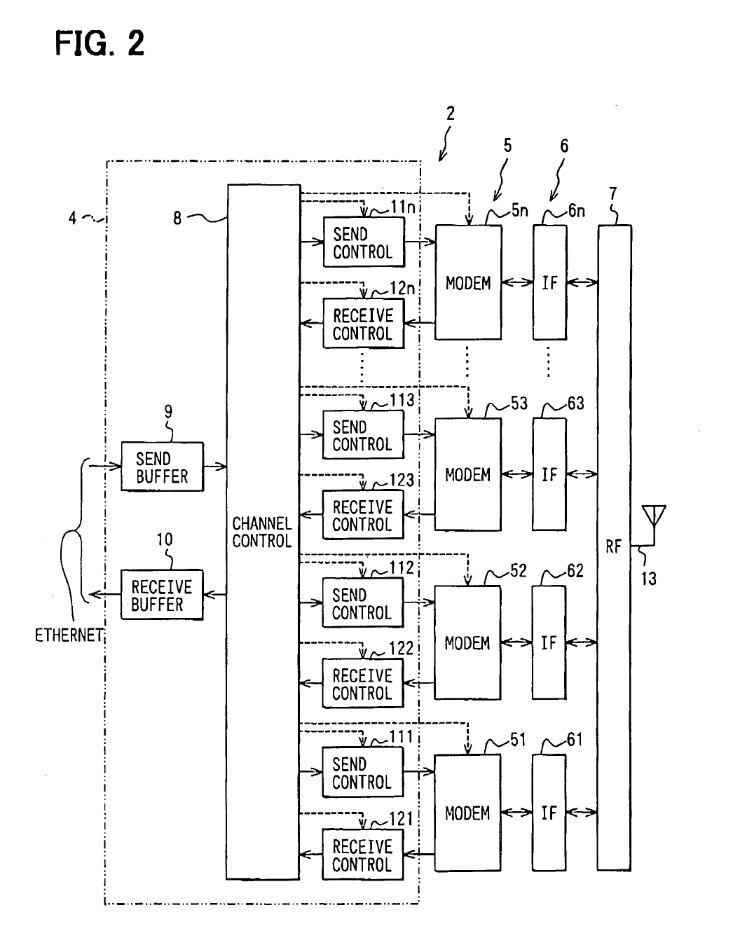

As shown in FIG. 2, the base station 2 comprises a communication control unit 4, a modem 5, an IF unit 6, and a RF unit 7. The communication control unit 4 comprises a channel controller 8 for controlling all operations of the base station 2, a sending buffer 9 for temporarily accumulating a send packet being sent to the terminal station 3, a receiving buffer 10 for temporarily accumulating a received packet received from the terminal station 3 sending control units 111 to 11n corresponding to each of a plurality of (n) channels or frequencies, and receiving control units 121 to 12n. Here, “n” is a natural number equal to 2 or more.

Send packets (data to be transmitted in packets) input into the sending buffer 9 from, for example, Ethernet (trade mark). When send packets are input through the channel controller 8 from the sending buffer 9, the respective sending control units 111 to 11n subject the input send packets to transmission processing to output the same to the respective modems 51 to 5n. When the send packets having been subjected to the transmission processing are input from the respective sending control units 111 to 11n, the respective modems 51 to 5n subject data row of the input send packets to modulation processing to output the same to the respective IF units 61 to 6n.

When signals of the data row of the send packets having been subjected to the modulation processing are input from the respective modems 51 to 5n, the respective IF units 61 to 6n up-convert the input signals to predetermined frequencies f1 to fn to output the same to the RF unit 7. Then, when signals having been up-converted are input from the respective IF units 61 to 6n, the RF unit 7 up-converts and subjects the input signals to summing processing corresponding to the plurality of channels to radiate the same as radio wave from an antenna 13.

The channel controller 8 outputs control signals to the respective sending control units 111 to 11n, the respective receiving control units 121 to 12n, and the respective modems 51 to 5n to thereby control the respective sending control units 111 to 11n, the respective receiving control units 121 to 12n, and the respective modems 51 to 5n. In addition, flows of control signals are indicated by arrows of broken line in FIG. 2 and flows of send packets and received packets are indicated by arrows of solid lines.

The above communication system 1, particularly the base station 2, operates as follows in the following processing (I) and (II).

(I) Processing, in which the base station 2 sends each of a plurality of send packets to the terminal station 3 in parallel through the plurality of channels as they are in packet unit.

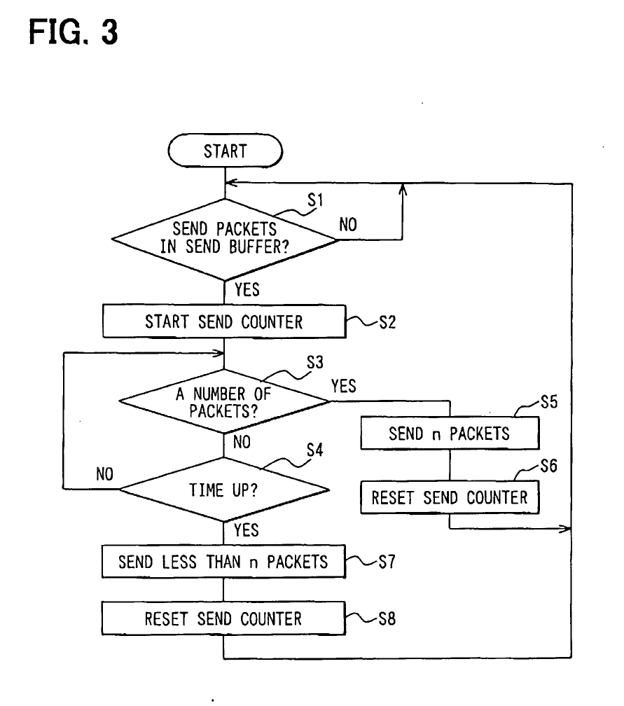

First, “processing, in which the base station 2 sends each of a plurality of send packets to the terminal station 3 in parallel through the plurality of channels as they are in packet unit (not divided into multiple units)” is described with reference to FIGS. 3 to 12A and 12B. FIG. 3 shows processing, in which the channel controller 8 performs in the base station 2.

The channel controller 8 periodically monitors whether the send packets are accumulated in the sending buffer 9 at step S1, and starts a sending counter (send timer) at step S2 when it is determined that send packets have been accumulated in the sending buffer 9 (“YES” at step S1).

Subsequently, the channel controller 8 monitors at step 53 whether the number of send packets having been accumulated in the sending buffer 9 is a prescribed number (n) and monitors at step S4 whether the sending counter has counted up (time up). That is, the controller 8 monitors whether the first predetermined period of time referred in the invention has elapsed. In this case, the prescribed number corresponds to a number up to the number of sending control units 111 to 11n (modems 51 to 5n and IF units 61 to 6n) on hardware, and is described here as “n”.

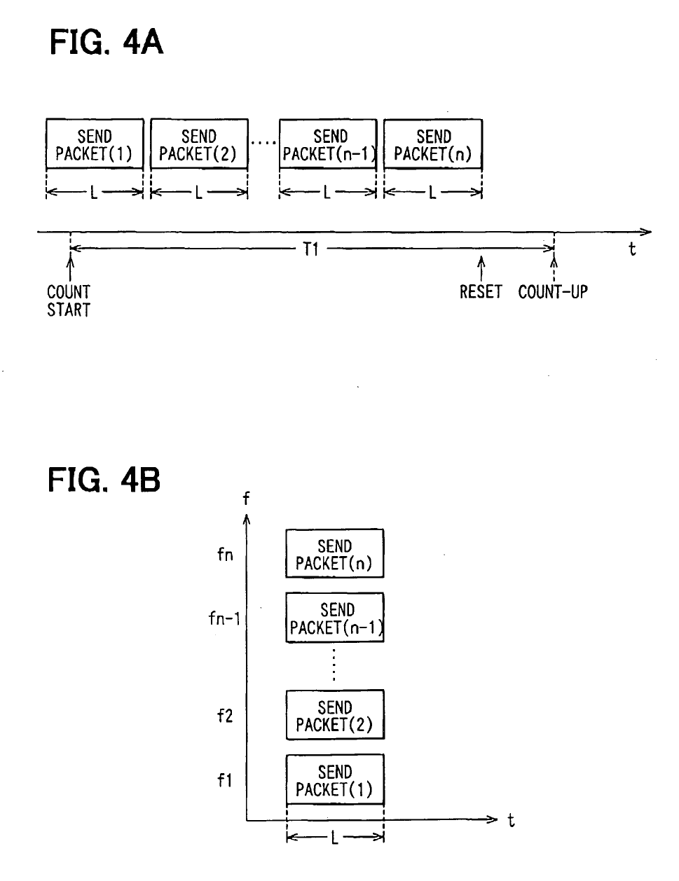

When it is determined, prior to counting-up of the sending counter that the number of send packets having been received and accumulated in the sending buffer 9 reaches the prescribed number n (“YES” at step S3) as shown in FIG. 4A, the channel controller 8 causes the sending buffer 9 to output to the respective sending control units 111 to 11n the n send packets having been accumulated in the sending buffer 9 at that time whereby the n send packets are sent to the terminal station 3 in parallel through the n channels at step S5 as shown in FIG. 4B.

Then the channel controller 8 resets the sending counter at step S6 and returns to step S1 to perform the above processing repeatedly.

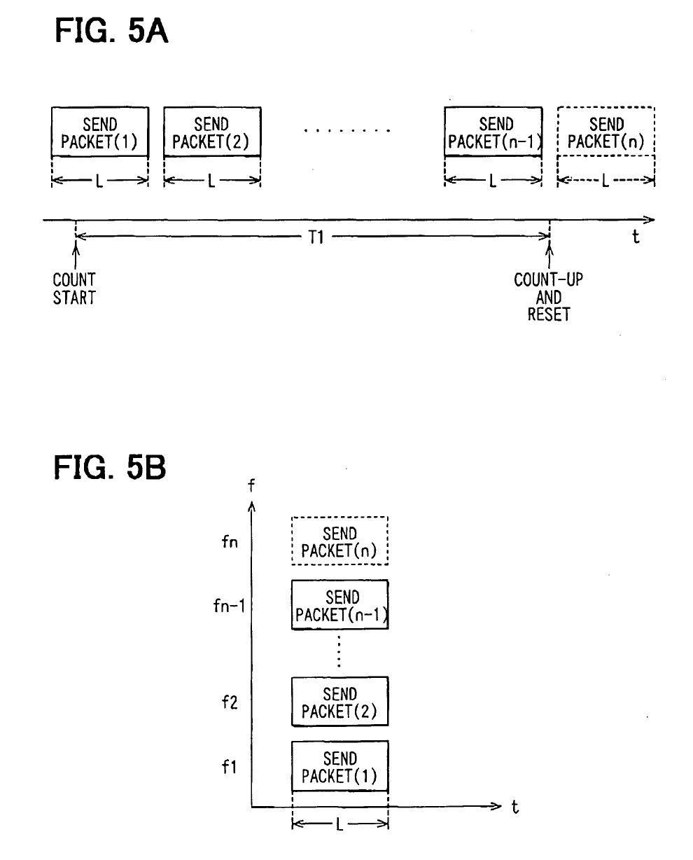

As shown in FIGS. 5A and 5B, when counting-up of the sending counter is determined, before the number of send packets having been accumulated in the sending buffer 9 reaches the prescribed number n (“YES” at step S4), the channel controller 8 causes the sending buffer 9 to output from the sending buffer 9 to the respective sending control units of less than n send packets of less than n (e.g., n−1) having been accumulated in the sending buffer 9 at that time whereby send packets of l ss than n are sent to the terminal station 3 in parallel through the n channels through the n channels at step S7.

The channel controller 8 resets the sending counter at step S8 and returns to step S1 to perform the above processing repeatedly. In addition, when the number of send packets accumulated in the sending buffer 9 at the time of counting-up of the sending counter is less than n−1, the channel controller 8 send packets of less than n−1. In addition, FIGS. 4A and 5A show a prescribed count time (time from starting to counting-up) of the sending counter as “T1”, and the prescribed count time of the sending counter can be set as desired according to, for example, a configuration of the system.

In the processing described above, the base station 2 sends each of n send packets through n channels in parallel to the terminal station 3 as they are in packet unit instead of dividing each of n send packets to send the same to the terminal station 3.

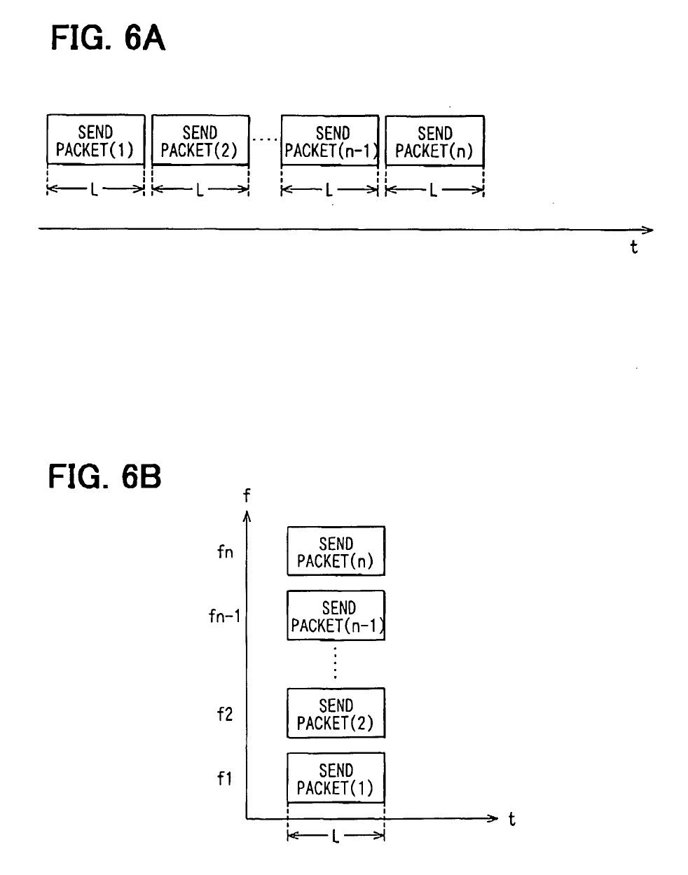

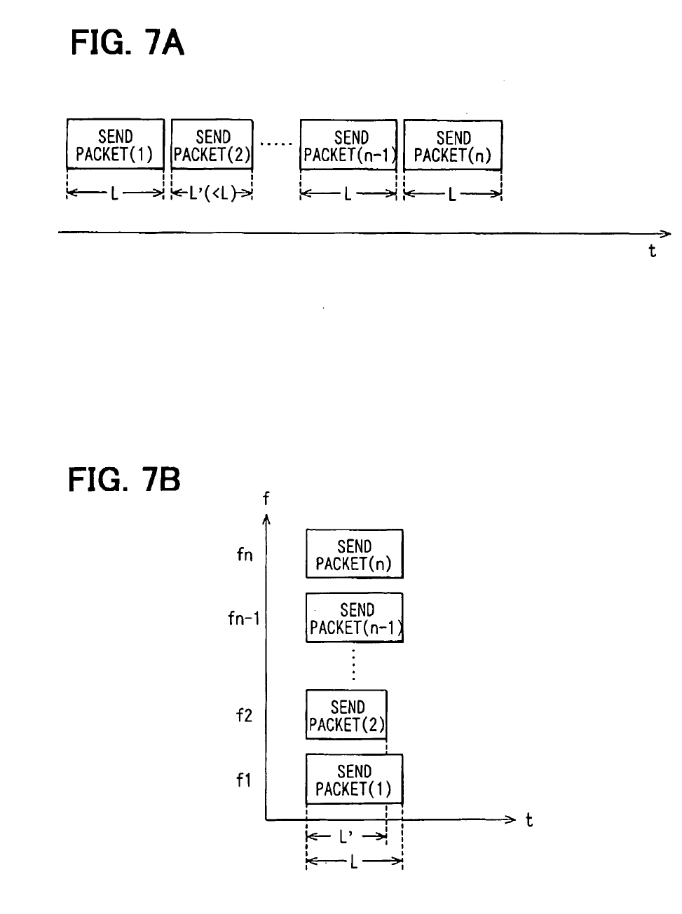

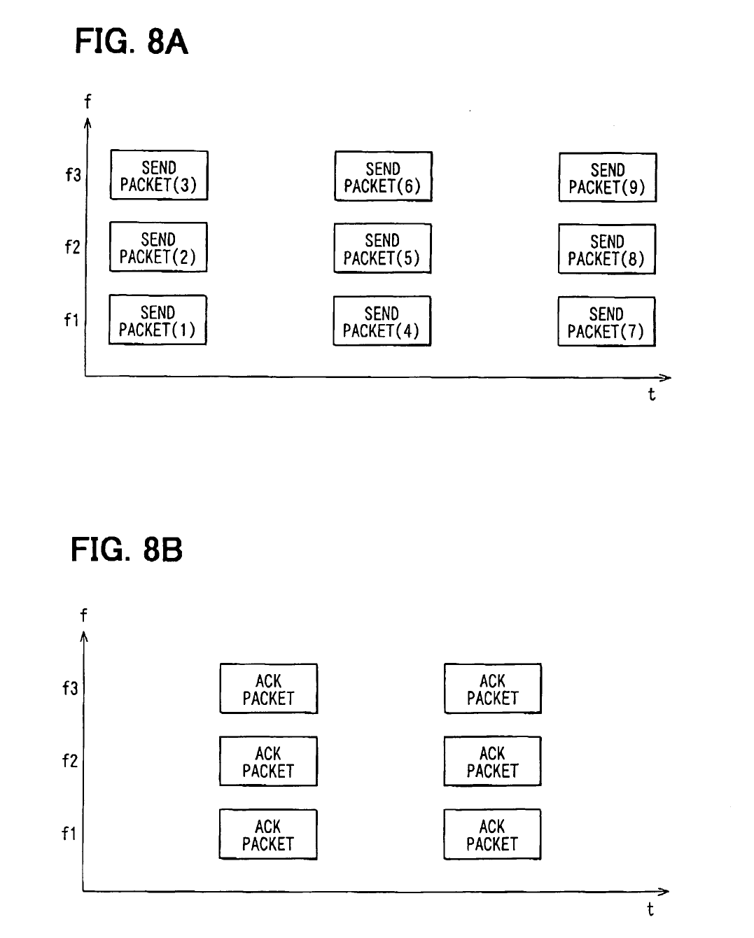

While the base station 2 can of course send, as shown in FIGS. 6A and 6B, n send packets of the same packet length (data amount) L through n channels in parallel to the terminal station 3, it can also send, as shown in FIGS. 7A and 7B, n send packets of different packet lengths (L and L′) to the terminal station 3 in parallel through the n channels. In FIGS. 7A and 7B, the second send packet (2) is different in packet length from other packets.

After the send packets are sent to the terminal station 3 as shown in FIG. 8A, the base station 2 monitors whether acknowledge (ACK) packets sent from the terminal station 3 as shown in FIG. 8B have been received within a prescribed time. When it is determined that the ACK packets from the terminal station 3 have not been received within the prescribed time, the base station 2 can also resend to the terminal station 3 the send packet which have not been received.

More specifically, the base station 2 starts an ACK packet receiving counter immediately after the send packets have been sent to the terminal station 3, and monitors whether the ACK packets from the terminal station 3 have been received and whether the ACK packet receiving counter has counted up, that is, whether a second predetermined time has elapsed. Then, when it is determined that the ACK packets from the terminal station 3 are received before the ACK packet receiving counter counts up, the base station 2 recognizes that send packets have been normally received by the terminal station 3.

When the counting-up of the ACK packet receiving counter is detected before the ACK packets from the terminal station 3 are received, the base station 2 recognizes that the send packets have not been normally received by the terminal station 3, and resends to the terminal station 3 the send packets which have not been normally received.

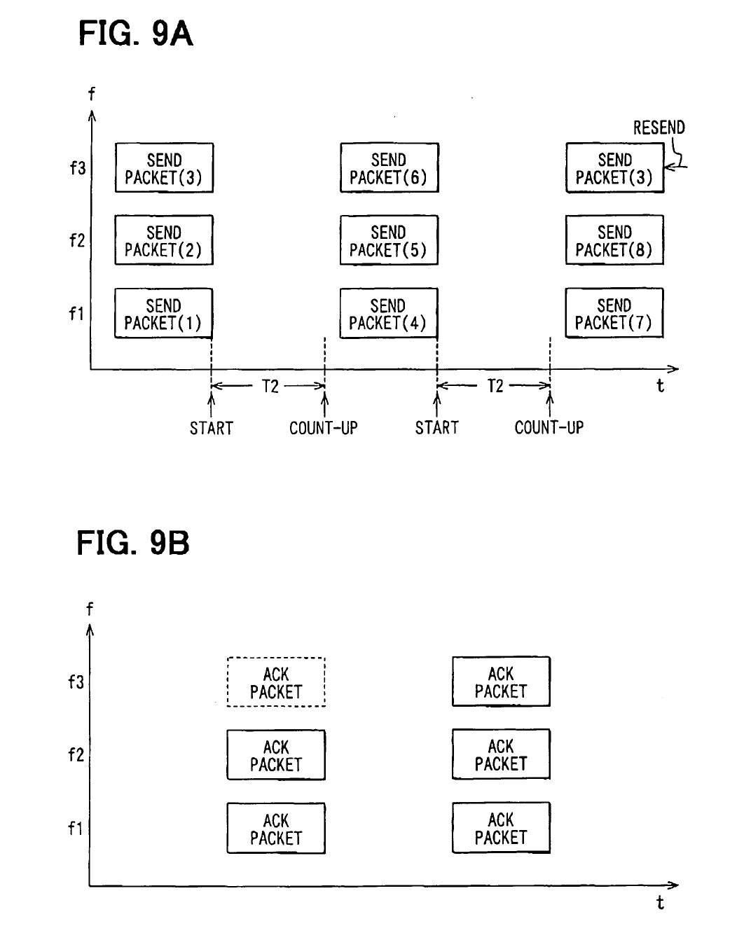

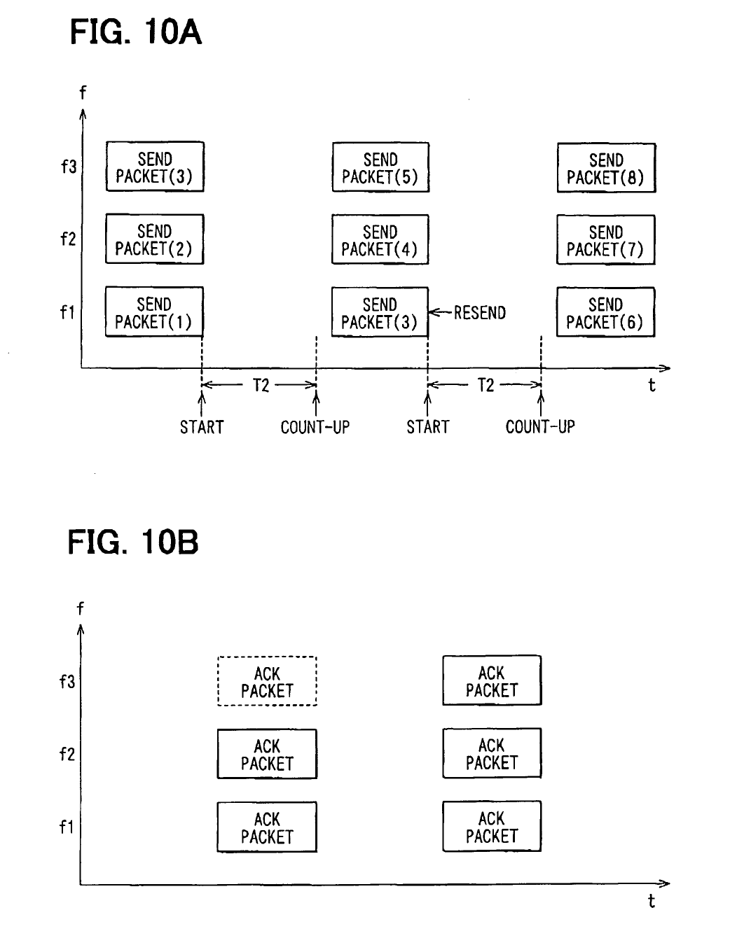

In this case, the base station 2 can also resend, as shown in FIG. 9A, to the terminal station 3 a send packet (a send packet (3) in FIG. 9A) when no ACK packet corresponding to the send packet (3) is received as shown by the dotted rectangle in FIG. 9B, after a predetermined number of send packets (send packets (4) to (6) in FIG. 9A) are sent since it is determined that the ACK packet receiving counter counts up, and can also resend, as shown in FIG. 10A, to the terminal station 3 a send packet (send packet (3) in FIG. 10A) immediately after the ACK packet receiving counter counts up. In FIGS. 9A and 10A show a prescribed count time (time from starting to counting-up) of the ACK packet receiving counter as “T2”, and the prescribed count time of the ACK packet receiving counter can also be set arbitrarily according to, for example, a configuration of the communication system in the same manner as the prescribed count time of the sending counter.

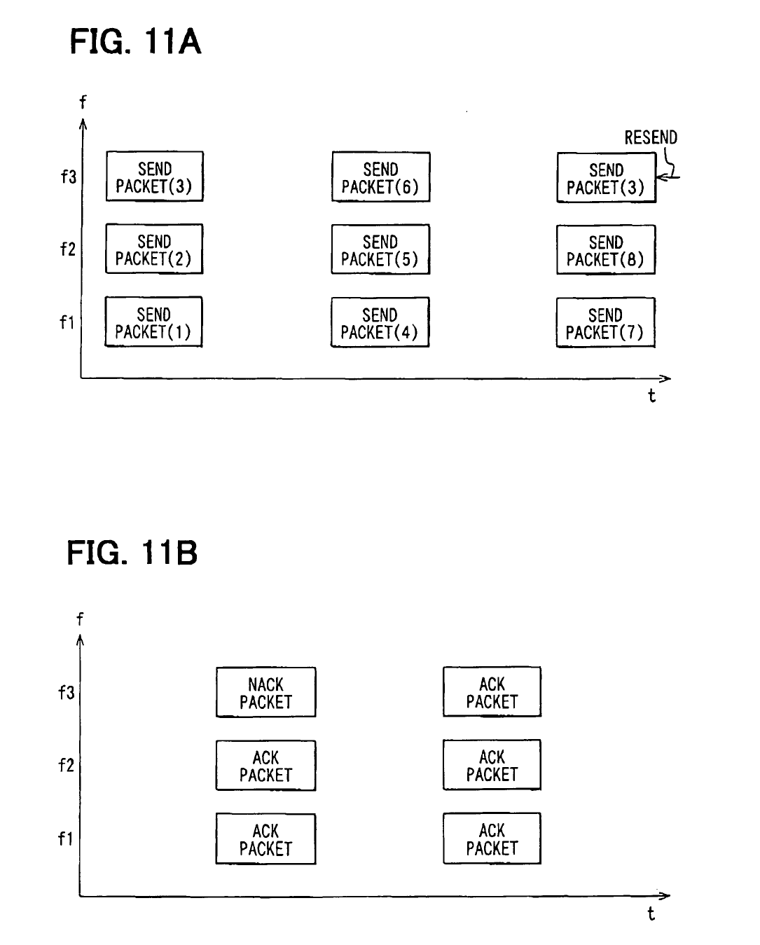

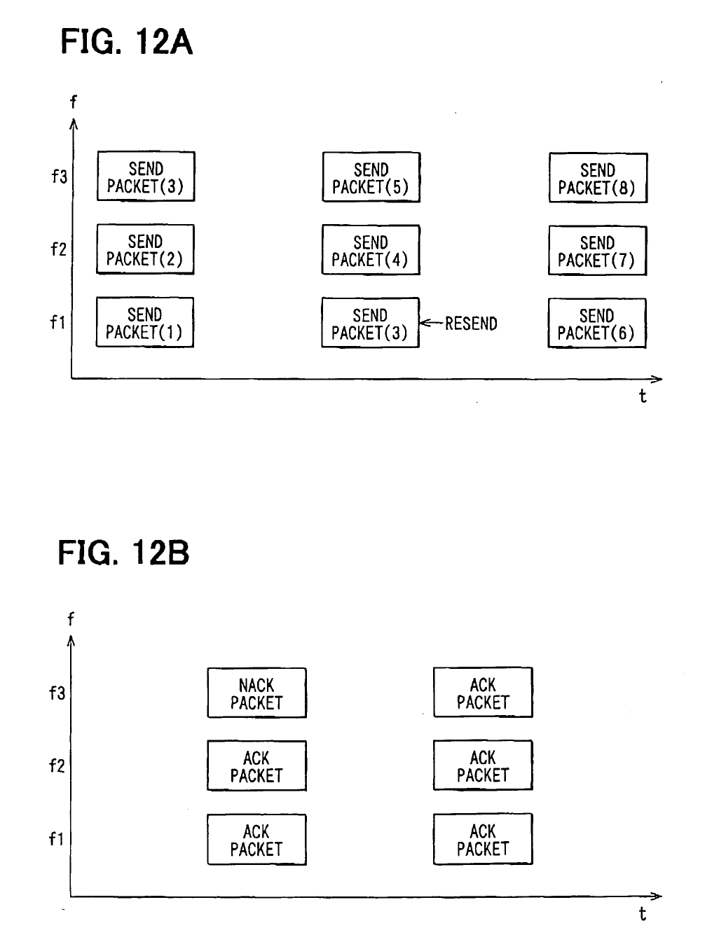

After the send packets are sent to the terminal station 3, the base station 2 monitors, as shown in FIGS. 11A, 11B, 12A and 12B, whether ACK packets and NACK (no acknowledgement) packets from the terminal station 3 have been received. When it is determined that the NACK packet from the terminal station 3 has been received, the base station 2 can also resend to the terminal station 3 the send packet which have not been normally received by the terminal station.

More specifically, when a plurality of send packets from the base station 2 have been received, the terminal station 3 sends an ACK packet to the base station 2 within a prescribed time with respect to each of the received send packets when it is determined that the send packets have been normally received. When it is determined that the send packets have not been normally received, the terminal station 3 sends the NACK packet to the base station 2 within the prescribed time.

Correspondingly, on the basis of determining that the ACK packets from the terminal station 3 have been received within the prescribed time, the base station 2 recognizes that the send packets have been normally received by the terminal station 3. On the basis of determining that NACK packets from the terminal station 3 have been received within the prescribed time, the base station 2 recognizes that the send packets have not been normally received by the terminal station 3. When it is determined that the NACK packets from the terminal station 3 have been received, the base station 2 resends to the terminal station 3 the send packet which has not been normally received.

In this case, the base station 2 can also resend, as shown in FIG. 11A, to the terminal station 3 the send packet (send packet (3) in FIG. 11A) which has not been normally received, after a predetermined number of send packets (send packets (4) to (6) in FIG. 11A) are sent since the NACK packet from the terminal station 3 is received. It can also resend, as shown in FIG. 12A, to the terminal station 3 the send packet (send packet (3) in FIG. 12A) which has not been normally received, immediately after the NACK packet from the terminal station 3 is received.

(II) Processing of registering and authenticating whether the base station 2 and the terminal station 3 are in the relationship between a master station and a slave station in a plurality of channels.

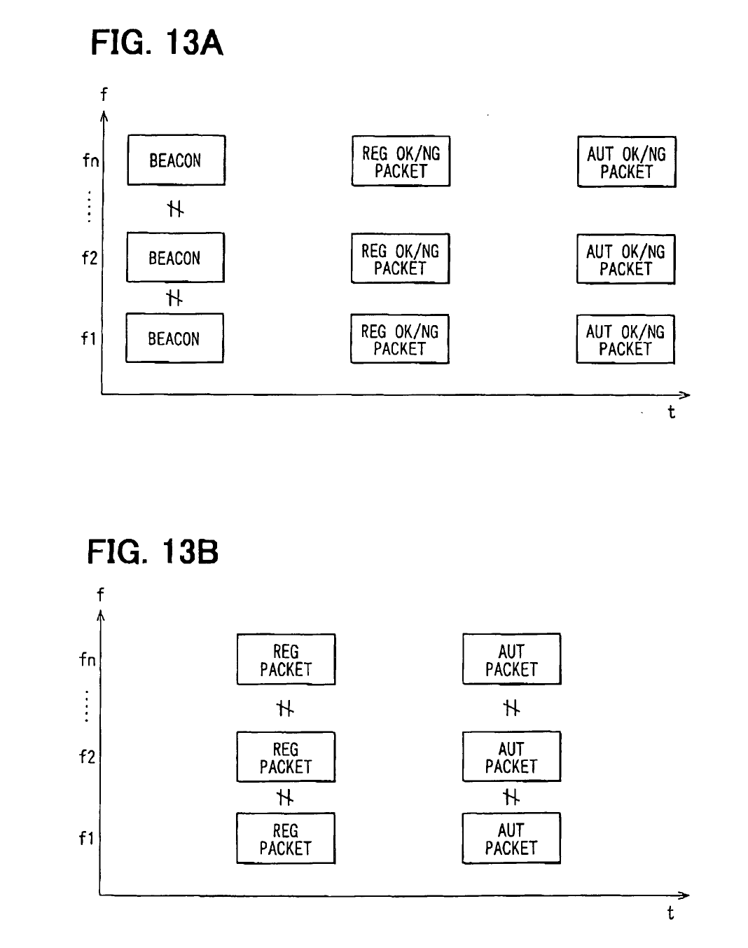

Subsequently, “processing of registering and authenticating whether the base station 2 and the terminal station 3 are in the relationship between a master station and a slave station in a plurality of channels”is d scribed with reference to FIGS. 13A, 13B, 14A, 14B, 15A and 15B. Here, the following methods of registering and authenticating whether the base station 2 and the terminal station 3 are in the relationship between a master station and a slave station in a plurality of channels are consecutively described.

(II-1) Processing of sending and receiving beacon, registration packets and authentication packets as independent data through a plurality of channels between the base station 2 and the terminal station 3 to thereby register and authenticate whether the base station 2 and the terminal station 3 are in the relationship between a master station and a slave station in a plurality of channels

(II-2) Processing of sending and receiving beacon, registration packets and authentication packets are sent and received as common data through a plurality of channels between the base station 2 and the terminal station 3 to thereby register and authenticate whether the base station 2 and the terminal station 3 are in the relationship between a master station and a slave station in a plurality of channels.

(II-3) Processing of sending and receiving beacon, registration packets and authentication packets are sent and received through an exclusive single channel between the base station 2 and the terminal station 3 to thereby register and authenticate whether the base station 2 and the terminal station 3 are in the relationship between a master station and a slave station in a plurality of channels.

In this case, upon receipt of registration packets from the terminal station 3, the base station 2 accepts demands for registration from the terminal station 3. When the registration of the terminal station 3 is normally completed, the base station 2 accepts demands for authentication from the terminal station. 3 upon receipt of authentication packets from the terminal station 3. It is assumed that the authentication is performed continuously after registration is normally completed, and authentication is normally completed. Also, while the operation of the communication system is described with reference to the case where the base station 2 sends beacon to the terminal station 3, the same operation is performed in the case where the terminal station 3 sends beacon to the base station 2 and further in the case where the base station 2 sends beacon to another base station 2 (not shown) and the case where the terminal station 3 sends beacon to another terminal station 3 (not shown).

(II-1) Processing of sending and receiving beacons, registration packets, and authentication packets as independent data through a plurality of channels between the base station 2 and the terminal station 3 to thereby register and authenticate whether the base station 2 and the terminal station 3 are in the relationship between a master station and a slave station in a plurality of channels

As shown in FIGS. 13A, the base station 2 sends each of the n beacons as independent data through n channels to the terminal station 3 synchronously in parallel through the n channels. In this case, information (BSSID and so on) stor d in each of the n beacons is different from one another. Subsequently, when receiving then beacons from the base station 2, the terminal station 3 sends each of n registration packets as independent data through then channels to the terminal station 3 synchronously in parallel through the n channels as shown in FIG. 13B.

Subsequently, when receiving the n registration packets from the terminal station 3, the base station 2 accepts demands for registration from the terminal station 3. When registration is normally completed, the base station 2 sends each of n packets, of which registration is correct (OK) or not (NG), as independent data through the n channels to the terminal station 3 synchronously in parallel through the n channels. Subsequently, when receiving the n packets, of which registration is correct or not, from the base station 2, the terminal station 3 sends each of the n authentication packets as independent data through the n channels to the base station 2 synchronously in parallel through the n channels.

When receiving the n authentication packets from the terminal station 3, the base station 2 accepts demands for authentication from the terminal station 3. When the authentication is normally completed, the base station 2 sends each of the n packets, of which the authentication is correct (OK) or not (NG), as independent data through the n channels to the terminal station 3 synchronously in parallel through the n channels.

Through the above processing, by sending and receiving the beacons, registration packets, packets, of which registration is correct or not, authentication packets, and packets, of which authentication is correct or not, in each of n channels between the base station 2 and the terminal station 3 in the same procedure as that of the registration and the authentication when the send packets are sent and received through a single channel, it is registered and authenticated whether the base station 2 and the terminal station 3 are in the relationship between a master station and a slave station in n channels.

(III-2) Processing of sending and receiving beacons, registration packets, and authentication packets as common data through a plurality of channels between the base station 2 and the terminal station 3 to thereby register and authenticate whether the base station 2 and the terminal station 3 are in the relationship between a master station and a slave station in a plurality of channels.

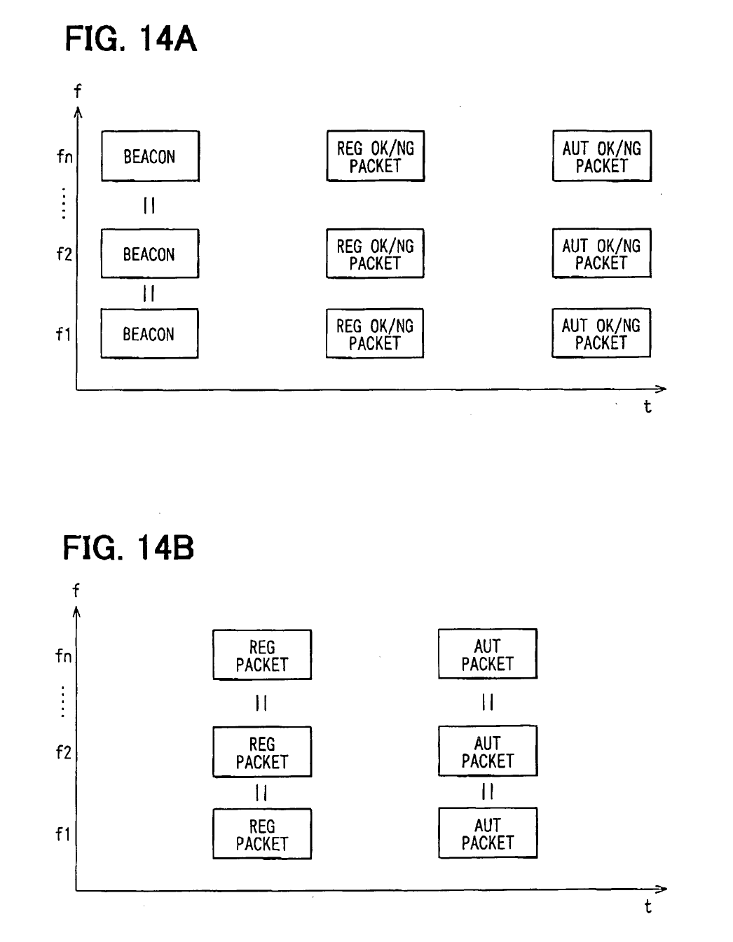

The base station 2 stores in each of the n beacons a base station identifier individually designated every base station, and sends each of the n beacons, in which such base station identifiers are stored, as common data through a plurality of channels to the terminal station 3 synchronously in parallel through the n channels as shown in FIG. 14A.

Subsequently, when receiving the n beacons from the base station 2, the terminal station 3 recognizes that the base station identifiers stored in each of the received n beacons are common to the n channels, store in each of the n registration packets a terminal station identifier individually designated every terminal station 3, and send each of the n registration packets, in which such terminal station identifiers are stored, as common data through the n channels to the base station 2 synchronously in parallel through the n channels as shown in FIG. 14B.

Subsequently, when receiving the n registration packets from the terminal station 3, the base station 2 accepts demands for registration from the terminal station 3 and recognizes that the terminal station identifiers stored in each of the received n registration packets are common to the n channels. When the registration is normally completed, the base station 2 sends each of the n packets, of which registration is correct (OK) or not (NG), as independent data through n channels to the terminal station 3 synchronously in parallel through the n channels.

Subsequently, when receiving the n registered and authentication packets from the base station 2, the terminal station 3 stores in each of the n authentication packets a terminal station identifier individually designated every terminal station 3, and sends each of n authentication packets, in which such terminal station identifiers are stored, as common data through the n channels to the base station 2 synchronously in parallel through the n channels.

When receiving the n authentication packets from the terminal station 3, the base station 2 accepts demands for authentication from the terminal station 3 and recognizes that the terminal station identifiers stored in each of the received n authentication packets are common to the n channels and that the terminal station 3 is the slave station common to the n channels, and sends each of the n packets, of which the authentication is correct (OK) or not (NG), as independent data through n channels to the terminal station 3 synchronously in parallel through the n channels.

Through the above processing, also in this case, by sending and receiving beacons, registration packets, packets, of which registration is correct or not, authentication packets, and packets, of which authentication is correct or not, through each of the n channels between the base station 2 and the terminal station 3 in the same procedure as that of registration and authentication when send packets are sent and received through a single channel, it is registered and authenticated whether the base station 2 and the terminal station 3 are in the relationship between a master station and a slave station in n channels.

(II-3) Processing of sending and receiving beacons, registration packets, and authentication packets through an exclusive single channel between the base station 2 and the terminal station 3 to thereby register and authenticate whether the base station 2 and the terminal station 3 are in the relationship between a master station and a slave station in a plurality of channels

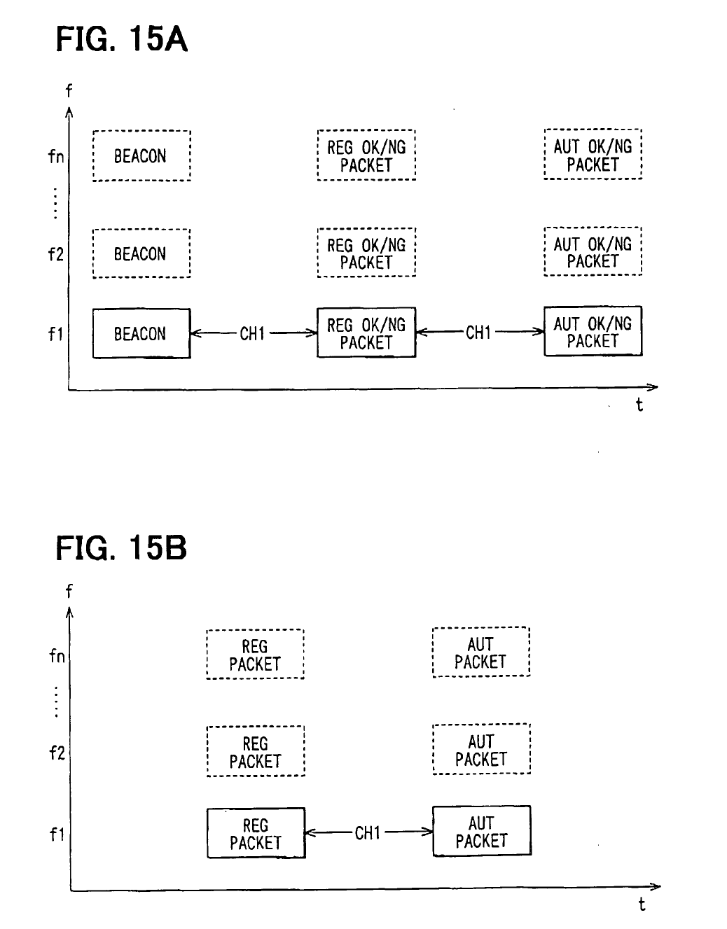

The base station 2 stores one beacon a base station identifier individually designated every base station 2, and sends one beacon, in which such base station identifier is stored, through a single exclusive channel CH1 (f1) in FIG. 15A to the terminal station 3.

Subsequently, when receiving the beacon from the base station 2, the terminal station 3 recognizes that the base station identifier stored in the received one beacon is common to the n channels, stores in one registration packet a terminal station identifier individually designated every terminal station 3, and sends one registration packet, in which such terminal station identifier is stored, through the single exclusive channel CH1 to the base station 2 as shown in FIG. 15B.

Subsequently, when receiving the registration packet from the terminal station 3, the base station 2 accepts a demand for registration from the terminal station 3 and recognizes that the terminal station identifier stored in the received one registration packet is common to the n channels. When the registration is normally completed, the base station 2 sends one packet indicating whether registration is correct (OK) or not (NG), through the single exclusive channel to the terminal station 3.

Subsequently, when receiving the packet indicating whether the registration is correct or not from the base station 2, the terminal station 3 stores in one authentication packet a terminal station identifier individually designated every terminal station 3, and sends one authentication packet, in which such terminal station identifier is stored, through the single exclusive channel to the base station 2.

When receiving the authentication packet from the terminal station 3, the base station 2 accepts a demand for authentication from the terminal station 3 and recognizes that a terminal station identifier stored in the received one authentication packet is common to the n channels and that the terminal station 3 is the slave station common to the n channels, and sends one packet indicating whether the authentication is correct (OK) or not (NG), through the single exclusive channel to the terminal station 3.

Through the above processing, beacons, registration packets, packets indicating whether registration is correct or not, authentication packets, and packets indicating whether authentication is correct or not, are sent and received through the single exclusive channel representative of n channels between the base station 2 and the terminal station 3 in the same procedure as that of registration and authentication when the send packets are sent and received through the single channel whereby it is registered and authenticated whether the base station 2 and the terminal station 3 are in the relationship between a master station and a slave station in n channels.

In the above embodiment, the registration and authentication are performed in the same way. However, the registration and the authentication can be performed in different ways. That is, for example, by adopting the processing (II-1) in the registration and the processing (II-2) in the authentication, it is also possible to register and authenticate whether the base station 2 and the terminal station 3 are in the relationship between a master station and a slave station in a plurality of channels.

According to the embodiment, in the case where the base station 2 sends the packets to the terminal station 3 in the radio communication system 1, instead of dividing each of the n send packets to send the same to the terminal station 3, each of the n send packets is sent in parallel through the n channels to the terminal station 3 as it is in a packet unit, so that the base station 2 can dispense with processing of division of send packets and processing of sending divided send packets, and the terminal station 3 do not need a configuration of receiving the divided send packets whereby processing in the base station 2 and the terminal station 3 can be made simple.

Also, as the terminal station 3, a station designed to receive send packets in parallel through n channels are not only used but also even a station designed to receive send packets through a single channel can be used, so that the terminal station for receiving send packets in parallel through n channels and the terminal station 3 for receiving send packets through a single channel can be made coexistent.

Also, since the base station 2 sends each of the n send packets through the n channels to the terminal station 3 as it is in packet unit when accumulation of n send packets is completed before the sending counter counts up, the n send packets can be rapidly sent to the terminal station 3 at a point of time when accumulation of the n send packets is completed. In contrast, since when the sending counter counts up before accumulation of the n send packets is completed, the base station 2 sends each of th send packets of less than n through channels of less than n to the terminal station 3 as it is in packet unit, delay in sending of the send packets can be restricted to a minimum by setting time in advance, which is allowable as a delay in sending, as a count time of the sending counter.

Also, since the terminal station 3 sends the ACK packets as independent data through the n channels to the base station 2 when the send packets are normally received by the terminal station 3, the terminal station 3 sends the ACK packets to thereby have the base station 2 recognizing that the send packets from the base station 2 have been normally received, and the ACK packets from the terminal station 3 are received before the ACK packet receiving counter counts up whereby the base station 2 can correspondingly recognize that send packets sent to the terminal station 3 before reception of the ACK packets have been normally received by the terminal station 3.

Since when the ACK packet receiving counter counts up before the ACK packets from the terminal station 3 are received, the base station 2 sends those send packets, which are not normally received by the terminal station 3, to the terminal station 3, the terminal station 3 can thereafter get a chance of receiving those send packets from the base station 2, which have not been normally received, even when send packets from the base station 2 have not been normally received. Also, by resending send packets as they are in packet unit, the procedure of resending when a single send packet is to be sent through a single channel, can be adopted, so that it is possible to restrict modification in communication control procedure as much as possible.

Also, the terminal station 3 sends NACK packets as independent data through the n channels to the base station 2 when send packets are not normally received by the terminal station 3, and the terminal station 3 sends the ACK packets as independent data through the n channels to the base station 2 when the send packets are normally received by the terminal station 3. Thus, the terminal station 3 sends both ACK packet and NACK packet to the base station 2 to thereby have the base station 2 recognize whether the send packets from the base station 2 have been normally received, and the ACK packet and NACK packet from the terminal station 3 are received whereby the base station 2 can correspondingly recognize whether the send packets sent to the terminal station 3 before reception of the ACK packet and NACK packet have been normally received by the terminal station 3.

When the NACK packet from the terminal station 3 is received by the base station 2, the base station 2 resends those send packets, which are not normally received by the terminal station 3, to the terminal station 3. Thus, the terminal station 3 can thereafter get a chance of receiving those send packets from the base station 2, which have not been normally received, even when the send packets from the base station 2 have not been normally received. Also, by resending he send packets as they are in packet unit, the procedure of resending when a single send packet is to be re-sent through a single channel, can be adopted, so that it is possible to restrict modification in communication control procedure as much as possible.

Also, the first method of registering and authenticating whether the base station 2 and the terminal station 3 are in the relationship between a master station and a slave station in the n channels in the radio communication system 1 is configured such that the base station 2 sends each of the n beacons, which corresponds to each of the n channels, as independent data through the n channels to the terminal station 3 in parallel through the n channels, the terminal station 3 sends each of the n registration packets and the n authentication packets, which corresponds to each of the n channels, as independent data through the n channels to the base station 2 in parallel through the n channels. The base station 2 sends each of the n packets indicating whether the registration is correct or not, and the n packets indicating whether the authentication is correct or not, each such packets corresponding to each of the n channels, as independent data through n channels to the terminal station 3 in parallel through the n channels. Thus, the beacons, registration packets, packets indicating whether the registration is correct or not, authentication packets, and packets indicating whether the authentication is correct or not are sent and received through each of the n channels between the base station 2 and the terminal station 3 in the same procedure as that of registration and the authentication when send packets are sent and received through a single channel. Thus, it is possible to appropriately register and authenticate whether the base station 2 and the terminal station 3 are in the relationship between a master station and a slave station in n channels.

Also, the second method of registering and authenticating whether the base station 2 and the terminal station 3 are in the relationship between a master station and a slave station in the n channels in the radio communication system 1 is configured such that the base station 2 sends each of the n beacons, which corresponds to each of the n channels, as common data through the n channels to the terminal station 3 in parallel through the n channels. The terminal station 3 sends each of n registration packets and the n authentication packets, which corresponds to each of the n channels, as common data through the n channels to the base station 2 in parallel through the n channels. The base station 2 sends each of the n packets indicating whether the registration is correct or not, and the n packets indicating whether the authentication is correct or not, each such packet corresponding to each of the n channels, as independent data through n channels to the terminal station 3 in parallel through the n channels. Thus, the beacons, registration packets, packets indicating whether the registration is correct or not, authentication packets, and packets indicating whether the authentication is correct or not are sent and received through each of the n channels between the base station 2 and the terminal station 3 in the same procedure as that of registration and authentication when the send packets are sent and received through a single channel. Thus, it is possible to appropriately register and authenticate whether the base station 2 and the terminal station 3 are in the relationship between a master station and a slave station in n channels in the same manner as in the first method.

Also, the third method of appropriately registering and authenticating whether the base station 2 and the terminal station 3 are in the relationship between a master station and a slave station in n channels in the radio communication system 1 is configured such that the base station 2 sends a single beacon representatively corresponding to each of then channels through a single exclusive channel to the terminal station 3. The terminal station 3 sends a single registration packet and a single authentication packet representatively corresponding to each of n channels, through a single exclusive channel to the base station 2. The base station 2 sends a single packet indicating whether the registration is correct or not, and a single packet indicating whether the authentication is correct or not. These single packets representatively correspond to each of the n channels, through a single exclusive channel to the terminal station 3. Thus, the beacons, registration packets, packets indicating whether the registration is correct or not, authentication packets, and packets indicating whether the authentication is correct or not are sent and received through a single exclusive channel representative of n channels between the base station 2 and the terminal station 3 in the same procedure as that of registration and authentication when send packets are sent and received through a single channel. Thus, it is possible to appropriately register and authenticate whether the base station 2 and the terminal station 3 are in the relationship between a master station and a slave station in n channels in the same manner as in the first and second methods.

Even when the terminal station 3 is designed to receive the send packets through a single channel, it is possible in these first, second and third methods to appropriately register and authenticate whether the base station 2 and the terminal station 3 are put in the relationship between a master station and a slave station, and to make the terminal station 3 for reception of the send packets in parallel through then channels and the terminal station 3 for reception of the send packets through a single channel coexistent. Also, it is possible to use the procedure of registration and authentication when the send packets are sent and received through a single channel and to restrict modification in communication control procedure as much as possible.

Further, as compared with the first method, it is possible in the second and third methods to eliminate the need of managing each of the n beacons as different data from one another and to eliminate the need of managing each of the n registration packets and the n authentication packets as different data from one another, thus enabling control simple.

The invention is not limited only to the above embodiments but also can be modified and extended in the following manner. The invention is not limited to a configuration, in which the channel controller periodically monitors whether the send packets are accumulated in the sending buffer but also may adopt a configuration, in which n send packets are automatically output to the respective sending control units at a point of time when the sending buffer has completed accumulation of n send packets.

1. A radio communication system comprising:
a base station and a terminal station provided as one and another communication stations,
wherein the one communication station is constructed to send each of a plurality of send packets to the another communication station in parallel through a plurality of channels as one packet unit.

2. The radio communication system as in claim 1,
wherein the one communication station is constructed to send, after accumulation of n send packets has been completed, each of n send packets through n channels to the another communication station as one packet unit, the n being a natural number equal to or more than 2.

3. The radio communication system as in claim 2,
wherein the one communication station is constructed to send, after a predetermined period of time has elapsed before the accumulation of n send packets is completed, each of m send packets, accumulation of which has been completed in the predetermined period, through m channels to the another communication station as one packet unit, the m being a natural number and smaller than n.

4. The radio communication system as in claim 1,
wherein the another communication station is constructed to send an ACK packet to the one communication station as independent data through the plurality of channels with respect to each of a plurality of send packets received from the one communication station, after the send packet is normally received from the one communication station, the ACK packet indicating that each of the send packet has been normally received.

5. The radio communication system as in claim 4,
wherein the one communication station is constructed resend the send packet, which has not been normally received by the another communication station, to the another communication station after a predetermined period of time has elapsed before the ACK packet is received from the another communication station.

6. The radio communication system as in claim 1,
wherein the another communication station is constructed to send an ACK packet to the one communication station as independent data through the plurality of channels with respect to each of the plurality of send packets received from the one communication station, after the send packet has been normally received from the one communication station, the ACK packet indicating that the send packet has been normally received, and
wherein the another communication station is constructed to send a NACK packet to the one communication station as independent data through the plurality of channels after the send packet has not been normally received from the one communication station, the NACK packet indicating that the send packet has not been normally received.

7. The radio communication system as in claim 6,
wherein the one communication station is constructed to resend the send packet, which has not been normally received by the another communication station, to the another communication station, after the NACK packet has been received from the another communication station.

8. A communication station for operating as a base station or a terminal station,
wherein the communication station is constructed to send each of a plurality of send packets in parallel through a plurality of channels to an another communication station as one packet unit.

9. A communication station for operating as a base station or a terminal station,
wherein the communication station is constructed to receive a plurality of send packets from another communication station, and
wherein the communication station is constructed to send an ACK packet to the another communication station as independent data through the plurality of channels with respect to each of the plurality of send packets received from the another communication station, after the send packet has been normally received from the another communication station, the ACK packet indicating that the send packet has been normally received.

10. The communication station as in claim 9,
wherein the communication station sends a NACK packet to another communication station as independent data through the plurality of channels after the send packet has not been normally received from the another communication station, the NACK packet indicating that the send packet has not been normally received.

11. A radio communication system comprising:
a base station and a terminal station provided as one and another communication stations,
wherein the one communication station is constructed to send each of a plurality of beacons in parallel through the plurality of channels to the another communication station as independent data through the plurality of channels, each of the beacons corresponding to each of the plurality of channels,
the another communication station is constructed to send each of a plurality of registration packets and a plurality of authentication packets in parallel through the plurality of channels to the one communication station as independent data through after each of the plurality of beacons has been received from the one communication station, and
the one communication station is constructed to send each of a plurality of packets indicating whether a registration is correct or not and each of a plurality of packets indicating whether an authentication is correct or not in parallel through the plurality of channels to the another communication station as independent data, each of such packets corresponding to each of the plurality of channels, after each of the plurality of registration packets and the plurality of authentication packets is received from the another communication station.

12. The radio communication system as in claim 11,
wherein the one communication station is constructed to send the plurality of beacons to the another communication station synchronously,
wherein the another communication station is constructed to send the plurality of registration packets and the plurality of authentication packets to the one communication station synchronously, and
wherein the one communication station is constructed to send to the another communication station synchronously the plurality of packets indicating whether the registration is correct or not and the plurality of packets indicating whether the authentication is correct or not.

13. A communication station for operating as a base station or a terminal station,
wherein the communication station is constructed to send each of a plurality of beacons, which corresponds to each of a plurality of channels, in parallel through the plurality of channels to another communication station as independent data, and
wherein the communication station is constructed to send each of a plurality of packets indicating whether a registration is correct or not and a plurality of packets indicating whether an authentication is correct or not, each of such packets corresponding to each of the plurality of channels, in parallel through the plurality of channels to the another communication station as independent data after each of the plurality of registration packets and the plurality of authentication packets is received from the another communication station.

14. A communication station for operating as a base station or a terminal station,
wherein the communication station is constructed to send each of a plurality of registration packets and a plurality of authentication packets, which corresponds to each of a plurality of channels, in parallel through the plurality of channels to the another communication station as independent data after each of the plurality of beacons is received from the another communication station.

15. A radio communication system comprising:
a base station and a terminal station provided as one and another communication stations,
wherein the one communication station is constructed to send each of a plurality of beacons, which corresponds to each of a plurality of channels, in parallel through the plurality of channels to the another communication station as common data through the plurality of channels,
wherein the another communication station is constructed to send each of a plurality of registration packets and a plurality of authentication packets, which corresponds to each of a plurality of channels, in parallel through the plurality of channels to the one communication station as the common data through the plurality of channels after each of the plurality of beacons has been received from the one communication station, and
wherein the one communication station is constructed to send each of a plurality of packets indicating whether a registration is correct or not and a plurality of packets indicating whether an authentication is correct or not, each of such packets corresponding to each of the plurality of channels, in parallel through the plurality of channels to the another communication station as independent data through the plurality of channels after each of the plurality of registration packets and the plurality of authentication packets is received from the another communication station.

16. The radio communication system as in claim 15,
wherein the one communication station is constructed to send a plurality of beacons to the another communication station synchronously,
wherein the another communication station is constructed to send a plurality of registration packets and a plurality of authentication packets to the one communication station synchronously, and
wherein the one communication station is constructed to send the plurality of packets indicating whether the registration is corrector not and the plurality of packets indicating whether the authentication is correct or not to the another communication station synchronously.

17. The radio communication system as in claim 15,
wherein the one communication station is constructed to store in each of the plurality of beacons a communication station identifier of the one communication station individually designated every communication station, and send each of the plurality of beacons, in which the communication station identifiers of the one communication station is stored, to the another communication station, and
wherein the another communication station is constructed to recognize that the communication station identifier of the one communication station stored in each of a plurality of beacons received from the one communication station is common to the plurality of channels, and sends each of the plurality of registration packets and the plurality of authentication packets to the one communication station.

18. The radio communication system as in claim 15,
wherein the another communication station is constructed to stores in each of the plurality of registration packets and the plurality of authentication packets the another communication station identifier individually designated every communication station, and sends each of the plurality of registration packets and the plurality of authentication packets, in which the another communication station identifiers are stored, to the one communication station, and
wherein the one communication station is constructed to recognize that another communication station identifier stored in each of a plurality of registration packets and a plurality of authentication packets received from the another communication is common to the plurality of channels, and send each of the plurality of packets indicating whether the registration is correct or not, and the plurality of packets, of which the authentication is correct or not, to the another communication station.

19. A communication station for operating as a base station or a terminal station,
wherein the communication station is constructed to send each of a plurality of beacons, which corresponds to each of a plurality of channels, in parallel through the plurality of channels to another communication station as common data, and
wherein the communication station is constructed to send each of a plurality of packets indicating whether a registration is correct or not and a plurality of packets indicating whether an authentication is correct or not, each of such packets corresponding to each of the plurality of channels, in parallel through the plurality of channels to the another communication station as independent data after each of the plurality of registration packets and the plurality of authentication packets is received from the another communication station.

20. The communication station as in claim 19,
wherein a communication station identifier of the communication station individually designated every communication station is stored in each of the plurality of beacons, and
wherein each of the plurality of beacons, in which the communication station identifiers of the one communication station are stored, is sent to the another communication station.

21. The communication station as in claim 19,
wherein an identifier of the another communication station stored in each of a plurality of registration packets and a plurality of authentication packets, which are received from the another communication station, is recognized as being common among the plurality of channels, and
wherein each of the plurality of packets indicating whether the registration is correct or not and the plurality of packets indicating whether the authentication is correct or not is sent to the another communication station.

22. A communication station for operating as a base station or a terminal station,
wherein the communication station is constructed to send each of a plurality of registration packets and a plurality of authentication packets, which correspond to each of a plurality of channels, in parallel through the plurality of channels to the another communication station as common data through the plurality of channels after each of a plurality of beacons is received from the another communication station.

23. The communication station as in claim 22,
wherein a communication station identifier of the communication station individually designated every communication station is stored in each of the plurality of registration packets and the plurality of authentication packets, and each of the plurality of registration packets and the plurality of authentication packets, in which the communication station identifiers of the communication stations are stored, is sent to the another communication station.

24. The communication station as in claim 22,
wherein the communication station identifier of the another communication station stored in each of a plurality of beacons, which are received from the another communication station, is recognized as being common among the plurality of channels, and
wherein each of the plurality of registration packets and the plurality of authentication packets is sent to th another communication station.

25. A radio communication system comprising:
a base station and a terminal station provided as one and another communication stations,
wherein the one communication station is constructed to send a single beacon, which representatively corresponds to each of a plurality of channels, through a single exclusive channel to the another communication station, and
wherein the another communication station is constructed to send a single registration packet and a single authentication packet, which representatively correspond to each of the plurality of channels, through the single exclusive channel to the one communication station after the single beacon has been received from the one communication station, and
wherein the one communication station is constructed to send a single packet indicating whether a registration is correct or not and a single packet indicating whether an authentication is correct or not, each of such packets representatively corresponding to each of the plurality of channels, through the single exclusive channel to the another communication station, after the single registration packet and the single authentication packet are received from the another communication station.

26. The radio communication system as in claim 25,
wherein the one communication station is constructed to store in the single beacon a communication station identifier of the one communication station individually designated every communication station, and send the single beacon, in which the communication station identifier of the one communication station is stored, to the another communication station, and
wherein the another communication station is constructed to recognize that the communication station identifier of the one communication station stored in the single beacon received from the one communication station is common to the plurality of channels, and send the single registration packet and the single authentication packet to the one communication station.

27. The radio communication system as in claim 25,
wherein the another communication station is constructed to store in a single registration packet and a single authentication packet a communication station identifier of the another communication station individually designated every communication station, and send a single registration packet and a single authentication packet, in which the communication station identifier of the another communication station is stored, to the one communication station, and
wherein the one communication station is constructed to recognize that the communication station identifier of the another communication station stored in the single registration packet and the single authentication packet is common to the plurality of channels, and send a single packet indicating whether a registration is correct or not and a single packet indicating whether an authentication is correct or not, to the another communication station.

28. A communication station for operating as a base station or a terminal station,
wherein the communication station is constructed to send a single beacon, which representatively corresponds to each of a plurality of channels, through a single exclusive channel to the another communication station, and
wherein the communication station is constructed to send a single packet indicating whether a registration is correct or not and a single packet indicating whether an authentication is correct or not, each of such packets representatively corresponding to each of the plurality of channels, through the single exclusive channel to the another communication station after a single registration packet and a single authentication packet are received from the another communication station.

29. The communication station as in claim 28,
wherein a communication station identifier of the communication station individually designated every communication station is stored in the single beacon, and
wherein the single beacon, in which the communication station identifier of the communication station is stored, is sent to the another communication station.

30. The communication station as in claim 28,
wherein a communication station identifier of the another communication station stored in a single registration packet and a single authentication packet, which are received from the another communication station, is recognized as being common among the plurality of channels, and
wherein a single packet indicating a registration is correct or not and a single packet indicating whether an authentication is correct or not are sent to the another communication station.

31. A communication station for operating as a base station or a terminal station,
wherein the communication station is constructed to send a single registration packet and a single authentication packet, which representatively correspond to each of a plurality of channels, through a single exclusive channel to another communication station after a single beacons is received from the another communication station.

32. The communication station as in claim 31,
wherein a communication station identifier of the communication station individually designated every communication station is stored in the single registration packet and the single authentication packet, and
wherein the single registration packet and the single authentication packet, in which the communication station identifier of the communication station is stored, are sent to the another communication station.

33. The communication station as in claim 31,
wherein a communication station identifier of the another communication station stored in the single beacon, which is received from the another communication station, is recognized as being common among the plurality of channels, and
wherein the single registration packet and the single authentication packet are sent to the another communication station.
